(19) United States
(12) Patent Application Publication
(10) Pub. No.: US 2010/0200426 A1
(43) Pub. Date: Aug. 12, 2010

(54) APPARATUS AND METHOD FOR PHASE SEPARATION OF LIQUIDS AND SOLIDS

(75) Inventor: TIMOTHY CAMISA, COLCHESTER, VT (US)

Correspondence Address: AKC PATENTS, 215 GROVE ST., NEWTON, MA, 02466, US

(73) Assignee: VERMONT ORGANICS RECLAMATION INC, WILLISTON, VT (US)

(21) Appl. No.: 12/702,518

(22) Filed: Feb. 9, 2010

Related U.S. Application Data
(60) Provisional application No. 61/151,328, filed on Feb. 10, 2009.

(51) Int. Cl. C02F 1/461; B01D 21/01; B03C 5/02

(52) U.S. Cl. 205/742; 210/208; 210/178; 204/666

(57) ABSTRACT

An improved nutrient separator for separating various solid components from liquid manure includes two coaxial containers that communicate at the bottom and provide for separate extraction of the solid manure components and liquids. The phase separator includes an outer container having a partially open frusto-conical bottom and an open top and an inner container being concentric with and contained within the outer container and having an open bottom communicating with the outer container's bottom. A space is formed between the outer container's inner side walls and the inner container's outer side walls. The separator also includes means for continuously transferring liquid manure into the inner container, means for adding a flocculant material into the inner container, means for stirring the flocculant material in the liquid manure contained in the inner container, means for conditioning the liquid manure to enhance phase separation of liquids and solid manure components from the liquid manure, settling of the separated solid manure components through the inner container's bottom into the outer container's bottom and accumulating of the separated liquids in the space, means for extracting the settled solid manure components from the outer container's bottom and means for extracting the separated liquids from the space's top.

### CROSS REFERENCE TO RELATED CO-PENDING APPLICATIONS

This application claims the benefit of U.S. provisional application Ser. No. 61/151,328 filed on Feb. 10, 2009 and entitled APPARATUS AND METHOD FOR PHASE SEPARATION OF LIQUIDS AND SOLIDS, which is commonly assigned, and the contents of which are expressly incorporated herein by reference.

### FIELD OF THE INVENTION

The present invention relates to an apparatus and a method for phase separation of liquids and solids, and more particularly to phase separation of liquid and solid components in a manure management system.

### BACKGROUND OF THE INVENTION

In the northern parts of the United States, dairy cattle are confined in dairy farms and fed with phosphate-rich feed during the long winter periods. During this long period of confinement, that lasts from the early fall until the early spring, the “in barn” produced manure accumulates in the farm. Similarly, poultry-based farms produce different but sometimes more concentrated manure. The concentrated manure from the dairy farms, the poultry farms or any other type of animal farms is usually stored outside of the barn in a manure pit and then spread over the fields in the spring. Government agencies have recommended this practice of spreading of manure over fields during spring as a method of disposing of agricultural waste while fertilizing the ground. This practice has led to purchase, maintenance and paying of taxes on land that is kept primarily for manure overspread, which is a major financial burden for the farmers.

Manure is composed of 96% water and of 4% solid nutrient materials. In other words, unprocessed manure is a very dilute source of fertilizing nutrients. Furthermore, studies have shown that phosphorous and other nutrients present in manure are water soluble, which causes these nutrients to be washed out by rain or snow. Therefore one ton of manure yields only 7 to 10 pounds of nutrients to the ground.

Spreading of manure is not allowed during the winter months on top of snow to prevent runoff of phosphates and other contaminants to nearby rivers, lakes and other groundwater systems with the melting of the snow. However, the process of spreading of the concentrated manure in the spring still causes excess runoff of phosphates and other contaminants to nearby rivers, lakes and other groundwater systems. Agricultural runoff, rich in nutrients like phosphorus and nitrogen has been linked to toxic microorganisms. These microorganisms are known to kill and/or cause diseases in fish and other animals and pose a serious health risk to humans.

Typical dairy manure contains nitrogen (N) and phosphorous (P) at a ratio of 3 to 1. The optimum fertilizer ratio of N:P for growing corn is 8 to 1. Therefore, the farmer has to spread in addition to the manure a large amount of urea for adding nitrogen in order to generate the required 8 to 1 ratio of N:P in the ground. Other plants require different ratios of N:P and the amount and type of additives need to be modified accordingly. This process of adding and spreading urea or other additives increases both the labor and material cost of farming and requires that the farmer goes out in the fields several times during the year.

As was mentioned above, phosphorus is water soluble which leads to phosphorus being washed out from the manure pit and soil by rain and carried to rivers, lakes and other groundwater systems, thereby causing pollution and reducing the fertilizing value of the manure. Also, nitrogen evaporates from the manure pit as ammonia which generates undesirable odors and causes the concentration of insects and vermin, while again reducing the fertilizing value of the manure.

Several prior art methods have been suggested for treating manure on the barn site and for converting manure to fertilizer. However, most of the prior art methods are not efficient, not scalable, or not economical and may require the addition of other chemicals for producing fertilizer.

Accordingly, there is a need for an efficient, scalable, economically viable and environmentally friendly process for treating manure and for producing stable custom fertilizer without the need to add chemicals.

### SUMMARY OF THE INVENTION

The invention features an improved manure management system and a method for processing liquid manure. The system includes a nutrient separator for separating various solid components of the liquid manure and clarifying water. The separator includes two coaxial tanks that communicate at the bottom and provide for separate extraction of the manure sludge and the clarified water.

In general, in one aspect, the invention features an apparatus for phase separation of liquids and solid manure components from liquid manure including an outer container having a partially open frusto-conical bottom and an open top and an inner container being concentric with and contained within the outer container and having an open bottom communicating with the outer container's bottom. A space is formed between the outer container's inner side walls and the inner container's outer side walls. The apparatus also includes means for continuously transferring liquid manure into the inner container, means for adding a flocculant material into the inner container, means for stirring the flocculant material in the liquid manure contained in the inner container, means for conditioning the liquid manure to enhance phase separation of liquids and solid manure components from the liquid manure, settling of the separated solid manure components through the inner container's bottom into the outer container's bottom and accumulating of the separated liquids in the space, means for extracting the settled solid manure components from the outer container's bottom and means for extracting the separated liquids from the space's top.

Implementations of this aspect of the invention may include one or more of the following features. The means for extracting the separated liquids may be a circular floating weir trough arrangement. The weir trough arrangement may have several entrance ports and a manifold path to an exit pipe or a single path to an exit pipe. The means for conditioning may be surfactants or foam controlling materials. The means for conditioning may be means for cooling or heating the inner container. The means for conditioning may be means for sealing the inner container and means for drawing vacuum on the inner container's top. The means for conditioning may be means for sealing the inner container and means for overpressurising the inner container. The apparatus may further include means for thermally insulating the outer container's outer surface. The inner container's volume and the outer container's volume are selected to optimize the settling of the solid manure components, the extracting of the settled solid manure components and the extracting of the separated liquids, while allowing for continuous transferring of the liquid manure into the inner container. The inner and outer containers may have cylindrical, hexagonal, rectangular, spherical, semispherical, vertical or horizontal geometries. The flocculant may be Fycosyllactose (C₁₈H₃₂O₁₅), Difucosyllactose (C₂₄H₄₂) 19), Lacto-N-tetraose (C₂₆H₄₅NO₂₁), Lacto-N-fucopentaose I (C₃₂H₅₅NO₂₅), Lacto-N-difucohexaose I (C₃₈H₆₅NO₂₉), Lacto-N-fucopentaose III, Monofucosyllacto-N-hexaose (C₄₆H₇₈N₂O₃₅), Difucosyllacto-N-hexaose (a) (C₅₂H₈₈N₂O₃₉), Difucosyllacto-N-neohexaose, Difucosyl-para-lacto-N-hexaose, Trifucosyllacto-N-hexaose (C₅₈H₉₈N₂O₄₃), Trifucosyl-para-lacto-N-hexaose, Sialyllactose (C₂₃H₃₉NO₁₉), Sialyllacto-N-tetraose (C₃₇H₆₂N₁₅O₂₉), Monofucosyl, monosialyllactose (C₂₉H₄₉NO₂₃), Monosialyl, monofucosyllacto-N-neotetraose (C₄₃H₇₂N₂O₃₃), Disialyllactose-N-tetraose (C₄₈H₇₉N₃O₃₇), A-pentasaccharide (C₃₂H₅₅NO₂₄), B-pentasaccharide (C₃₀H₅₂O₂₄), Oligomannose-3 (C₃₅H₅₈N₂O₂₆), Oligomannose-5 (C₄₆H₇₈N₂O₃₆), Oligomannose-6 (C₅₂H₈₈N₂O₄₁), Oligomannose-7D1 (C₅₈H₉₈N₂O₄₆), Oligomannose-7D2, Oligomannose-7D3, Oligomannose-8D1D3, Oligomannose-8D1D2 (C₆₄H₁₀₈N₂O₅₁), Oligomannose-8D2D3, Oligomannose-9 (C₇₀H₁₁₈N₂O₅₆), Asialo-biantennary (C₆₂H₁₀₄N₄O₄₆), Asialo-biantennary with core substituted fucose (C₆₈H₁₁₄N₄O₅₀), Disialyl-biantennary (C₈₄H₁₃₈N₆O₆₂), Oligomannose-3 substituted with fucose and xylose (C₄₅H₇₆N₂O₃₄), Oligomannose2(a) (C₂₈H₄₈N₂O₂₁, Oligomannose-4 (C₄₀H₆₈N₂O₃₁), Lacto-N-hexaose, Lacto-N-neohexaose, Monosialyl LNnH, Monosialyl monofucosyl LnnH, Disialyl monofucosyl LNH, Chitobiose, or Maltotriose. The flocculant may be lime, iron, aluminum, wollostonite, calcium, starches, proteins, gelatin, animal glue, polymeric compounds or food grade polymers.

In general, in another aspect, the invention features a system for processing liquid manure comprising a series arrangement of a plurality of equipment including first equipment for transferring the liquid manure into an input station, second equipment for separating a first manure component and a first overflow liquor from the liquid manure at a first processing station, third equipment for adding a first flocculant material to the first overflow liquor at the first processing station, fourth equipment for mechanically separating a second manure component and a second overflow liquor from the first overflow liquor at a second processing station, fifth equipment for performing direct current electrocoagulation cleaning of the second overflow liquor at a third processing station and separating a third manure component and a third overflow liquor and sixth equipment for performing clarifying cleaning of the third overflow liquor at an output station and separating a fourth manure component and water. The sixth equipment comprises an outer container having a partially open frusto-conical bottom and an open top, an inner container being concentric with and contained within the outer container and having an open bottom communicating with the outer container's bottom. A space is formed between the outer container's inner side walls and the inner container's outer side walls. The sixth equipment also includes means for continuously transferring liquid manure into the inner container, means for adding a second flocculant material into the inner container, means for stirring the second flocculant material in the liquid manure contained in the inner container, means for conditioning the liquid manure to enhance phase separation of liquids and solid manure components from the liquid manure, settling of the separated solid manure components through the inner container's bottom into the outer container's bottom and accumulating of the separated liquids in the space, means for extracting the settled solid manure components from the outer container's bottom and means for extracting the separated liquids from the space's top.

In general, in another aspect, the invention features a method for processing liquid manure including first transferring the liquid manure in an input station, then separating a first solid manure component and a first overflow liquor from the liquid manure at a first processing station via a first mechanical separation equipment, then adding a first flocculant material to the first overflow liquor at the first processing station, then separating a second solid manure component and a second overflow liquor from the first overflow liquor at a second processing station via a second mechanical separation equipment, then performing direct current electrocoagulation cleaning of the second overflow liquor at a third processing station and separating a third solid manure component and a third overflow liquor, and then performing clarifying cleaning of the third overflow liquor at an output station and separating a fourth solid manure component and water. The clarifying cleaning comprises entering the third overflow liquor into a phase separation equipment which includes an outer container having a partially open frusto-conical bottom and an open top, an inner container being concentric with and contained within the outer container and having an open bottom communicating with the outer container's bottom. A space is formed between the outer container's inner side walls and the inner container's outer side walls. The phase separation equipment also includes means for continuously transferring liquid manure into the inner container, means for adding a second flocculant material into the inner container, means for stirring the second flocculant material in the liquid manure contained in the inner container, means for conditioning the liquid manure to enhance phase separation of liquids and solid manure components from the liquid manure, settling of the separated solid manure components through the inner container's bottom into the outer container's bottom and accumulating of the separated liquids in the space, means for extracting the settled solid manure components from the outer container's bottom and means for extracting the separated liquids from the space's top.

Among the advantages of this invention may be one or more of the following. The nutrient separator allows for continuous operation with minimal interruption for removal of accumulated sludge in the settling tank. The separator provides for homogenizing and preconditioning the input stream. The separator provides for buffering of the properties of the input stream to optimized the settling process conditions resulting in more uniform characteristics of recovered grey water and nutrient rich sludge. The separator provides for control of foaming on the tank surface. The separator provides clear and continuous separation of the input and output streams and clear and continuous separation of the recovered grey water. The separator also provides stabilization of process conditions by thermally coupling the preconditioning and settling tanks and better energy use by thermally coupling preconditioning and settling tanks and isolating phase separation system from ambient conditions. The separator includes a floating weir that buffers the output flow rate from changes in the input flow rate. The improved system for manure processing shortens the manure processing cycle to 4 hours per cycle. The method is scalable, low cost, efficient and environmentally friendly.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

Referring to the figures, wherein like numerals represent like parts throughout the several views:

FIG. 1 is a diagrammatic view of the manure reclamation system of this invention;

FIG. 2 is a schematic diagram of the integrated manure management system;

FIG. 3 is a schematic diagram of a prior art clarifier/phase separator system;

FIG. 4 is a schematic diagram of the improved clarifier/phase separator system of this invention; and

FIG. 5 is a cross-sectional diagram of the clarifier/phase separator system of FIG. 4.

### DETAILED DESCRIPTION OF THE INVENTION

The invention features an optimized system and method for processing liquid manure and producing organic fertilizer. The system includes equipment for separating various components of the liquid manure having different nitrogen to phosphorous ratios and then mixing these components so as to produce an organic fertilizer with a predetermined nitrogen to phosphorus ratio.

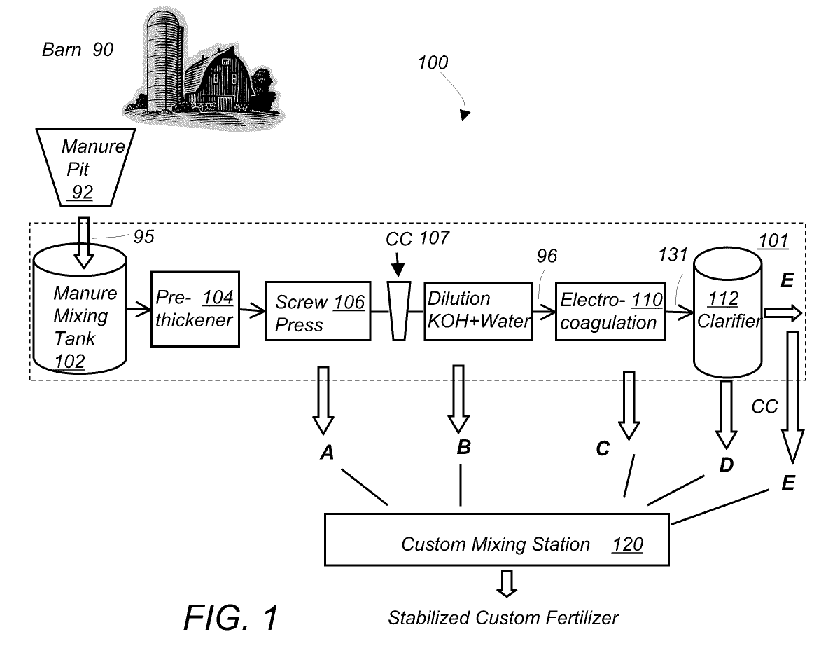

Referring to FIG. 1, a manure reclamation system 100 includes a manure treatment system 101 and a fertilizer production system 120. Manure 95 that accumulates in a manure pit 92 on the barn site 90 is introduced into a manure mixing tank 102. The manure 95 at this stage is in liquid form and is composed of about 92% to 96% water and 4% to 8% solids. The solids include, in addition to the dissolved manure, animal byproducts, such as pieces of tail, cow ears, nails, bedding, placenta, hair, grains, sand and other small particles. Several nutrients are dissolved in the water including phosphorus (P), nitrogen (N) and potassium (K), among others. The manure treatment process 101 includes separation of liquids from solids, collection of the separated solid materials at the various stages and treatment of the remaining liquid so that it can be discharged back into the fields. In the mixing tank 102 the big undissolved solid pieces are removed from the liquid manure and the remaining mixture is stirred in order to form a homogenous mixture. The liquid manure 95 leaves the mixing tank 102 and enters a pre-thickener station 104. The pre-thickener station 104 includes a stainless steel screen that strains and removes the excess water out. Next, the manure 95 passes through a screw press station 106. The screw press 106 separates the sludge component A from the manure. The sludge component A contains the best quality of manure, also called “cake”. The “cake” contains about 15% soluble P and 20% soluble N and it can be directly injected into the ground for fertilizing purposes. The “cake” is excellent for aerating clay type soils and the process of injecting the “cake” introduces the nutrients deep into the soil at about 4 to 8 inches depth from the surface.

Next, the remaining liquid manure solution is emptied into a container 107 and a flocculant component is added. The flocculant component is usually a mixture of inorganic and organic compounds. Inorganic flocculant compounds include iron, aluminum and minerals such as lime and wollostonite. Organic flocculant compounds include starches, proteins, gelatin, animal glue, polymeric compounds, and food grade polymers. A class of organic flocculant compounds that has been found to be especially efficient are complex carbohydrates (CC). Examples of complex carbohydrates include Fycosyllactose (C₁₈14₃₂O₁₅), Difucosyllactose (C₂₄H₄₂)₁₉), Lacto-N-tetraose (C₂₆H₄₅NO₂₁), Lacto-N-fucopentaose I (C₃₂H₅₅NO₂₅), Lacto-N-difucohexaose I(C₃₈H₆₅NO₂₉), Lacto-N-fucopentaose III, Monofucosyllacto-N-hexaose (C₄₆H₇₈N₂O₃₅), Difucosyllacto-N-hexaose (a) (C₅₂H₈₈N₂O₃₉), Difucosyllacto-N-neohexaose, Difucosyl-para-lacto-N-hexaose, Trifucosyllacto-N-hexaose (C₅₈H₉₈N₂O₄₃), Trifucosyl-para-lacto-N-hexaose, Sialyllactose (C₂₃H₃₉NO₁₉), Sialyllacto-N-tetraose (C₃₇H₆₂N₁₅O₂₉), Monofucosyl, monosialyllactose (C₂₉H₄₉NO₂₃), Monosialyl, monofucosyllacto-N-neotetraose (C₄₃H₇₂N₂O₃₃), Disialyllactose-N-tetraose (C₄₈H₇₉N₃O₃₇), A-pentasaccharide (C₃₂H₅₅NO₂₄), B-pentasaccharide (C₃₀H₅₂O₂₄), Oligomannose-3 (C₃₅H₅₈N₂O₂₆), Oligomannose-5 (C₄₆H₇₈N₂O₃₆), Oligomannose-6 (C₅₂H₈₈N₂O₄₁), Oligomannose-7D1 (C₅₈H₉₈N₂O₄₆), Oligomannose-7D2, Oligomannose-7D3, Oligomannose-8D1D3, Oligomannose-8D1D2 (C₆₄H₁₀₈N₂O₅₁), Oligomannose-8D2D3, Oligomannose-9 (C₇₀H₁₁₈N₂O₅₆), Asialo-biantennary (C₆₂H₁₀₄N₄O₄₆), Asialo-biantennary with core substituted fucose (C₆₈H₁₁₄N₄O₅₀), Disialyl-biantennary (C₈₄H₁₃₈N₆O₆₂), Oligomannose-3 substituted with fucose and xylose (C₄₅H₇₆N₂O₃₄), Oligomannose2(a) (C₂₈H₄₈N₂O₂₁, Oligomannose-4 (C₄₀H₆₈N₂O₃₁), Lacto-N-hexaose, Lacto-N-neohexaose, Monosialyl LNnH, Monosialyl monofucosyl LnnH, Disialyl monofucosyl LNH, Chitobiose, and Maltotriose. These complex carbohydrates are produced by GlycoTech, Gaithersburg, Md. 20879. Typical amounts of flocculants used are 1 gram per liter of manure. In addition to their role as flocculants, the complex carbohydrates contribute to electrically stabilizing the irrigation water so that Nitrogen remains in the solution and does not evaporate. Furthermore, complex carbohydrates form enzymes that further stabilize the soil from further leaching.

After the addition of the flocculant component the manure solution enters a second mixing tank 108. In the mixing tank 108 the manure solution is further diluted with KOH and water to 1:1 ratio. In one example, 500 gallons of water and KOH are added to 500 gallons of manure solution. The KOH reacts with the phosphorus in the manure solution to form KPO4, which is a stable fertilizer. The addition of KOH increases the solid content of the manure solution and raises the ph of the solution. The increased ph value improves the effect of the following electrocoagulation step.

Next, the diluted manure solution passes trough an electrocoagulation station 110. Electrocoagulation station 110 includes at least two metal plate electrodes (an anode and a cathode) that are connected to a DC current electrical source. The two most common plate materials are iron and aluminum. In accordance with Faraday's law, metal ions are split off or sacrificed into the liquid medium. These metal ions tend to form metal oxides that electromechanically attract to the various water contaminants. The electrocoagulation process destabilizes the suspended, emulsified or dissolved contaminants, attaches them to the metal ions and metal oxides and then carries them to the plate with the opposite charge. Generally, this state of stability produces a solid that is either less colloidal and less emulsified (or soluble) than the compound at equilibrium values. As this occurs, the contaminants form hydrophobic entities that precipitate and can easily be removed by a number of secondary separation techniques. Electrocoagulation removes all remaining unreacted phosphorous while leaving behind as much nitrogen as possible. Electrocoagulation also removes heavy metals, oxides, suspended colloidal solids, fats, oils, grease, and complex organic materials. Electrocoagulation also breaks oil emulsions and destroys and removes bacteria, viruses, cyst, microbia and other pathogenic microorganism.

Finally the remaining liquid passes through an atmospheric clarifying station/phase separation system 112, where the remaining insoluble components are separated from the water E. Water solution D contains 40% of insoluble N , KPO4 and no P. The nitrogen rich water solution D is further stabilized by adding CC and converting it into nitrate. Water E is free of any phosphorus, meets EPA standards for phosphorous surface release and is used for irrigation and as a fertilizer base of the surrounding fields. Water E may be collected in a perc pond or used for inground infiltration.

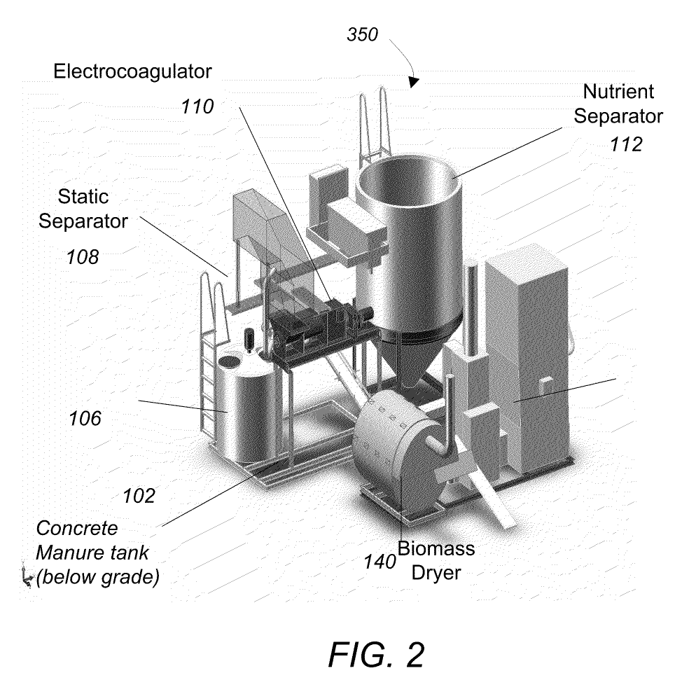

Referring to FIG. 2, an equipment system 350 for processing liquid manure includes a series arrangement of equipment including first equipment 95 for transferring manure in the manure tank 102, second a screw press 106 for separating a first manure component, third equipment 107 for adding a flocculant material to the first overflow liquor produced by the screw press 106, fourth a static separator 108 for separating a second manure component, fifth an electrocoagulator 110 for performing direct current electrocoagulation cleaning and producing a third manure component, sixth a clarifier/nutrient separator 112 for producing a fourth manure component and clarified water, and a biomass dryer 140 for drying any of the above mentioned manure components or mixtures thereof

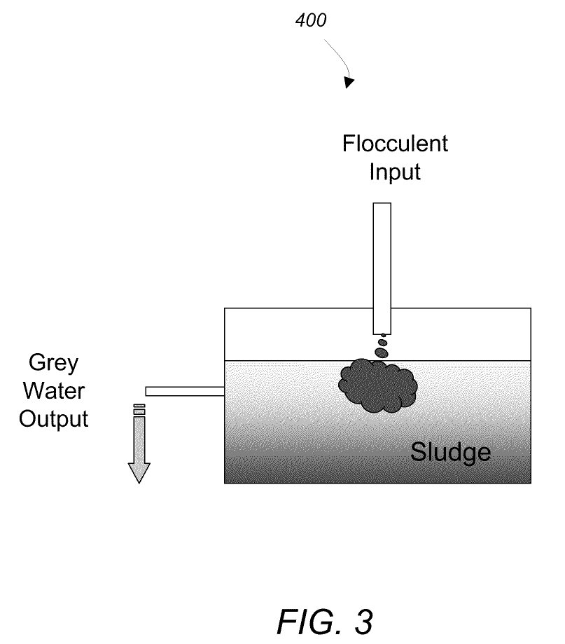

A prior art system 400 supporting a settling phase separation process that recovers grey water 420 while at the same time allows settling of the solid sludge components 410 is diagrammed in FIG. 3. Note that since sludge 410 accumulates in the tank 401 bottom in such a system, it will continually slow the rate of processing until at some point the process will have to be stopped to allow removal of the sludge. Such systems are common in, for example, residential septic systems.

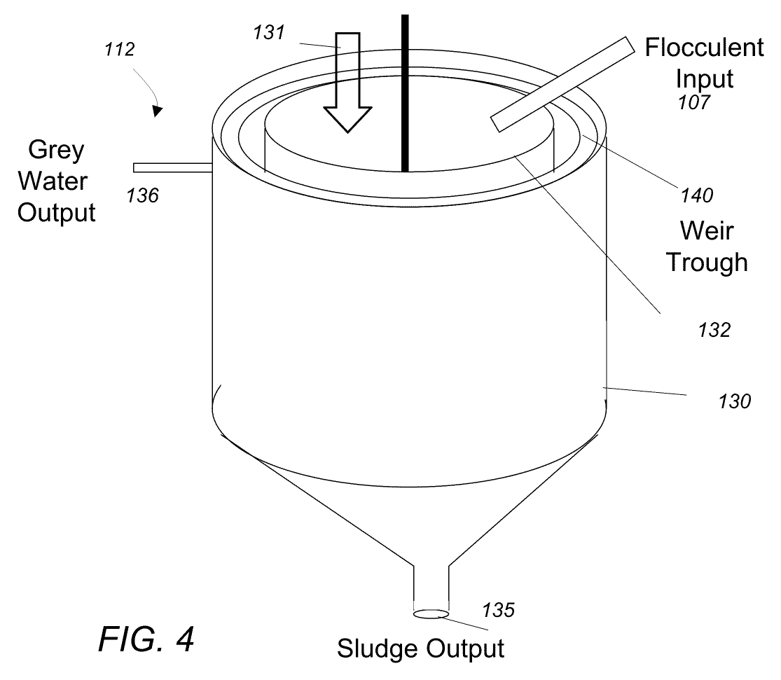

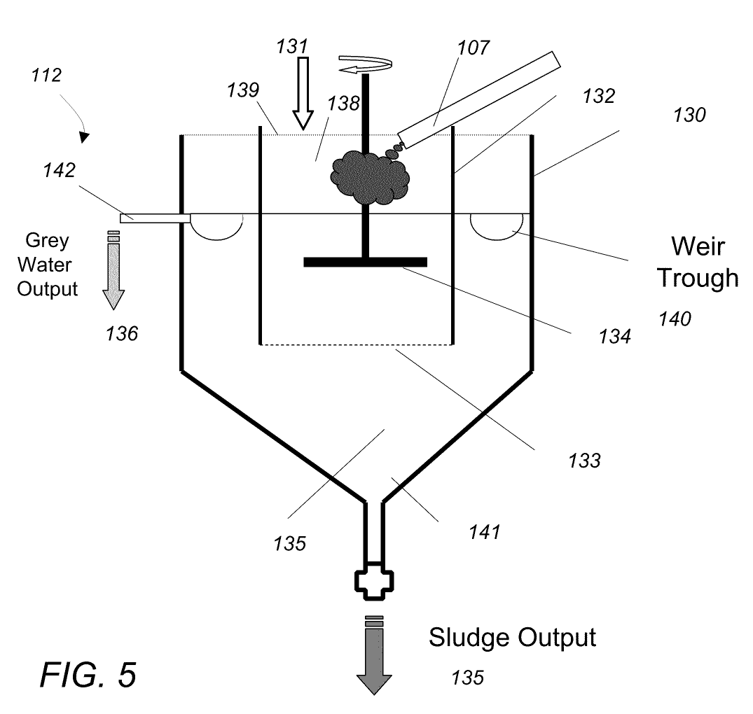

Using a cylindrical arrangement (shown in FIG. 4 and FIG. 5) for simplicity of showing the concept, two coaxial tanks 130, 132 are arranged with the inner tank 132 being continually fed the effluent 131 from the EC process 110. Provision is made in this inner tank 132 for stirring 134 or other means of agitating the input material 131 with the objective of both preventing settling in this inner tank 132 and homogenizing the concentration of the added flocculants 107, thus smoothing variation in the input material flocculent concentration. The bottom 133 of the inner tank is substantially open, except for structural elements for support and rigidity, allowing the solid components to settle. Provision is also made to seal the top 139 of the inner tank 132 to allow a vacuum to be drawn or overpressure provided to control the formation of foam 138 on the surface.

Provision is also made to allow the introduction of such materials as surfactants or other materials to control foaming, enhance settling rates, or otherwise improve the characteristics of the material in the inner tank for settling or later processing. This step is referred to as preconditioning. Provision may also be made in the preconditioning tank to heat or cool the input stream or the tank itself to further optimize processing conditions.

The preconditioned material is allowed to settle through the inner tank 132 so as to continually supply new materials to the outer or settling tank 130. Grey water 136 is continuously recovered from the top of the settling tank 130 via a circular, floating weir trough 140 arrangement typically provided with several entrance ports and a single or manifold path to the exit pipe 142. By floating the weir 140 the grey water 136 can be continuously extracted even as variations in the flow rates in the input stream. Alternatively, the weir 140 can be fixed in position and the input/output passages caused to vary in size to allow more or less flow according to variation in the input rate. This modulation is desirable so as to assure maximum uniformity in the grey water nutrient content.

Settling occurs continuously resulting in a gradual increase in flocculent/solid/sludge components 135 concentration to the bottom 141 of the outer tank 130. In this schematic the tank bottom 141 is cone shaped to enhance the flow of the sludge 135 to a centrally located sludge extraction valve. The rate of extraction can also be varied to assist in keeping constant process conditions. It may be advantageous to insulate the outer or settling tank 130 to buffer the settling process from variations in ambient temperature.

The volume of the tank(s) must accommodate the optimum settling time of the flocculants/solid components while maintaining sufficient fluidity of the sludge 135 and sufficient nutrient removal in the recovered grey water 136 while allowing for a nearly continuous input of EC effluent 131. In one example, for a system operating at an EC effluent rate of 15 gpm and an optimum settling time of 150 minute, the volume of the outer or settling tank is 1,125 gallons. Likewise, the volume of the inner or preconditioning tank 132 is also 1,125 gallons. For this operating point typical extraction rates of grey water 136 and nutrient rich sludge 135 are respectively, 12 and 3 gpm.

It is easily imagined how this arrangement can be extended to other geometries such as rectangular, hexagonal, horizontal cylindrical, or even abstract configurations as may be determined to be favorable from a production or system packaging perspective.

Other embodiments are within the scope of the following claims. For example, manure may be from cattle, poultry, sheep, pig or any other animal. The flocculant may be added at any of the process stations including the mixing tank, the pre-thickener, the electrocoagulation or the clarifier. Manure 95 may be introduced into the manure mixing tank 102 directly from the barn 90. Instead of KOH, calcium hydroxide Ca(OH)2 or lime can be used in the dilution tank 108. This results in the formation CaPO4, which is also no-soluble and is separated at the clarifier as component D.

Several embodiments of the present invention have been described. Nevertheless, it will be understood that various modifications may be made without departing from the spirit and scope of the invention. Accordingly, other embodiments are within the scope of the following claims.

What is claimed is:

1. An apparatus for phase separation of liquids and solid manure components from liquid manure comprising:
an outer container having a partially open frusto-conical bottom and an open top;
an inner container being concentric with and contained within said outer container and having an open bottom communicating with said outer container's bottom, and wherein a space is formed between said outer container's inner side walls and said inner container's outer side walls;
means for continuously transferring liquid manure into said inner container;
means for adding a flocculant material into said inner container;
means for stirring said flocculant material in said liquid manure contained in said inner container;
means for conditioning said liquid manure to enhance phase separation of liquids and solid manure components from said liquid manure, settling of said separated solid manure components through said inner container's bottom into said outer container's bottom and accumulating of said separated liquids in said space;
means for extracting said settled solid manure components from said outer container's bottom; and
means for extracting said separated liquids from said space's top.

2. The apparatus of claim 1 wherein said means for extracting said separated liquids comprises a circular floating weir trough arrangement.

3. The apparatus of claim 2 wherein said weir trough arrangement comprises several entrance ports and a manifold path to an exit pipe.

4. The apparatus of claim 2 wherein said weir trough arrangement comprises several entrance ports and a single path to an exit pipe.

5. The apparatus of claim 1 wherein said means for conditioning comprises one of surfactants or foam controlling materials.

6. The apparatus of claim 1 wherein said means for conditioning comprises means for cooling the inner container.

7. The apparatus of claim 1 wherein said means for conditioning comprises means for heating the inner container.

8. The apparatus of claim 1 wherein said means for conditioning comprises means for sealing said inner container and means for drawing vacuum on said inner container's top.

9. The apparatus of claim 1 wherein said means for conditioning comprises means for sealing said inner container and means for overpressurising said inner container.

10. The apparatus of claim 1 further comprising means for thermally insulating said outer container's outer surface.

11. The apparatus of claim 1 wherein said inner container's volume and said outer container's volume are selected to optimize said settling of said solid manure components, said extracting of said settled solid manure components and said extracting of said separated liquids, while allowing for continuous transferring of said liquid manure into said inner container.

12. The apparatus of claim wherein said inner and outer containers comprise one of cylindrical, hexagonal, rectangular, spherical, semispherical, vertical or horizontal geometries.

13. The apparatus of claim 1 wherein said flocculant comprises one of Fycosyllactose (C₁₈H₃₂O₁₅), Difucosyllactose (C₂₄14₄₂) ₁₉), Lacto-N-tetraose (C₂₆H₄₅NO₂₁), Lacto-N-fucopentaose I (C₃₂H₅₅NO₂₅), Lacto-N-difucohexaose I (C₃₈H₆₅NO₂₉), Lacto-N-fucopentaose III, Monofucosyllacto-N-hexaose (C₄₆H₇₈N₂O₃₅), Difucosyllacto-N-hexaose (a) (C₅₂H₈₈N₂O₃₉), Difucosyllacto-N-neohexaose, Difucosyl-para-lacto-N-hexaose, Trifucosyllacto-N-hexaose (C₅₈H₉₈N₂O₄₃), Trifucosyl-para-lacto-N-hexaose, Sialyllactose (C₂₃H₃₉NO₁₉), Sialyllacto-N-tetraose (C₃₇H₆₂N₁₅O₂₉), Monofucosyl, monosialyllactose (C₂₉H₄₉NO₂₃), Monosialyl, monofucosyllacto-N-neotetraose (C₄₃H₇₂N₂O₃₃), Disialyllactose-N-tetraose (C₄₈H₇₉N₃O₃₇), A-pentasaccharide (C₃₂H₅₅NO₂₄), B-pentasaccharide (C₃₀H₅₂O₂₄), Oligomannose-3 (C₃₅H₅₈N₂O₂₆), Oligomannose-5 (C₄₆H₇₈N₂O₃₆), Oligomannose-6 (C₅₂H₈₈N₂O₄₁), Oligomannose-7D1 (C₅₈H₉₈N₂O₄₆), Oligomannose-7D2, Oligomannose-7D3, Oligomannose-8D1D3,Oligomannose-8D1D2 (C₆₄H₁₀₈N₂O₅₁), Oligomannose-8D2D3, Oligomannose-9 (C₇₀H₁₁₈N₂O₅₆), Asialo-biantennary (C₆₂H₁₀₄N₄O₄₆)₅ Asialo-biantennary with core substituted fucose (C₆₈H₁₁₄N₄O₅₀), Disialyl-biantennary (C₈₄H₁₃₈N₆O₆₂), Oligomannose-3 substituted with fucose and xylose (C₄₅H₇₆N₂O₃₄), Oligomannose2(a) (C₂₈H₄₈N₂O₂₁, Oligomannose-4 (C₄₀H₆₈N₂O₃₁), Lacto-N-hexaose, Lacto-N-neohexaose, Monosialyl LNnH, Monosialyl monofucosyl LnnH, Disialyl monofucosyl LNH, Chitobiose, or Maltotriose.

14. The apparatus of claim 1 wherein said flocculant comprises one of lime, iron, aluminum, wollostonite, calcium, starches, proteins, gelatin, animal glue, polymeric compounds or food grade polymers.

15. A system for processing liquid manure comprising a series arrangement of a plurality of equipment said arrangement comprising:
first equipment for transferring said liquid manure into an input station;
second equipment for separating a first manure component and a first overflow liquor from said liquid manure at a first processing station;
third equipment for adding a first flocculant material to said first overflow liquor at said first processing station;
fourth equipment for mechanically separating a second manure component and a second overflow liquor from said first overflow liquor at a second processing station;
fifth equipment for performing direct current electrocoagulation cleaning of said second overflow liquor at a third processing station and separating a third manure component and a third overflow liquor; and
sixth equipment for performing clarifying cleaning of said third overflow liquor at an output station and separating a fourth manure component and water, and
wherein said sixth equipment comprises an outer container having a partially open frusto-conical bottom and an open top, an inner container being concentric with and contained within said outer container and having an open bottom communicating with said outer container's bottom, and wherein a space is formed between said outer container's inner side walls and said inner container's outer side walls, means for continuously transferring liquid manure into said inner container, means for adding a second flocculant material into said inner container, means for stirring said second flocculant material in said liquid manure contained in said inner container, means for conditioning said liquid manure to enhance phase separation of liquids and solid manure components from said liquid manure, settling of said separated solid manure components through said inner container's bottom into said outer container's bottom and accumulating of said separated liquids in said space, means for extracting said settled solid manure components from said outer container's bottom and means for extracting said separated liquids from said space's top.

16. A method for processing liquid manure comprising:
transferring said liquid manure in an input station;
separating a first solid manure component and a first overflow liquor from said liquid manure at a first processing station via a first mechanical separation equipment;
adding a first flocculant material to said first overflow liquor at said first processing station;
separating a second solid manure component and a second overflow liquor from said first overflow liquor at a second processing station via a second mechanical separation equipment;
performing direct current electrocoagulation cleaning of said second overflow liquor at a third processing station and separating a third solid manure component and a third overflow liquor; and
performing clarifying cleaning of said third overflow liquor at an output station and separating a fourth solid manure component and water, and
wherein said clarifying cleaning comprises entering said third overflow liquor into a phase separation equipment comprising wherein an outer container having a partially open frusto-conical bottom and an open top, an inner container being concentric with and contained within said outer container and having an open bottom communicating with said outer container's bottom, and wherein a space is formed between said outer container's inner side walls and said inner container's outer side walls, means for continuously transferring liquid manure into said inner container, means for adding a second flocculant material into said inner container, means for stirring said second flocculant material in said liquid manure contained in said inner container, means for conditioning said liquid manure to enhance phase separation of liquids and solid manure components from said liquid manure, settling of said separated solid manure components through said inner container's bottom into said outer container's bottom and accumulating of said separated liquids in said space, means for extracting said settled solid manure components from said outer container's bottom and means for extracting said separated liquids from said space's top.
